(19) United States
(12) Patent Application Publication
(10) Pub. No.: US 2024/0406564 A1
(43) Pub. Date: Dec. 5, 2024

(54) METHODS AND SYSTEMS FOR CREATING PANORAMIC IMAGES FOR DIGITALLY EXPLORING LOCATIONS

(71) Applicant: SkyScope Corporation, Victoria (CA)

(72) Inventor: Daniel Harmon di CLARE, Sooke (CA)

(21) Appl. No.: 18/327,942

(22) Filed: Jun. 2, 2023

(51) Int. Cl. H04N 23/698; B64U 80/30; H04N 23/661

(52) U.S. Cl. CPC H04N 23/698; B64U 80/30; H04N 23/661; B64U 2101/30; B64U 2201/10

(57) ABSTRACT

A method of creating panoramic images for digitally exploring locations is provided that includes creating flight plan instructions for an unmanned aerial vehicle over a target area, capturing, by the unmanned aerial vehicle, image data of the target area while executing the flight plan instructions and flying over the target area, creating a panoramic image of the target area from the captured image data, and storing the created panoramic image in a database of panoramic images. Each panoramic image corresponds to a different target area. Moreover, the method includes receiving, by an electronic device in communication with the database via a network, input for one of the different target areas to view the corresponding panoramic image. In response to determining a panoramic image is available for the one target area, the method displays the corresponding panoramic image.

### BACKGROUND OF THE INVENTION

This invention relates generally to panoramic images, and more particularly, to methods and systems for creating panoramic images for digitally exploring locations.

Known Geographic Information Systems rely on visualization tools that provide up-to-date and accurate location imagery which can be interacted with digitally for purposes of spatial analysis, urban planning and development, geographical education, and research, tourism and navigation, and marketing. It is known to use geo-visualization tools such as satellite imagery, maps, and Lidar to produce visual outputs of location information. However, a disadvantage of geo-visualization tools like satellite imagery is that the images do not have a high enough resolution of small, localized areas such as parks, businesses, and homes. As a result, satellite imagery and other known geo-visualization tools cannot provide images having resolution that provides the level of detail required to withstand the scrutiny encountered in tourism, exploration, marketing, site surveying, and urban planning.

Thus, it would be advantageous and an improvement over the relevant technology to provide a method, an electronic device, and a non-transitory recording medium capable of generating images of adequate resolution that include the level of detail required to withstand the scrutiny encountered in tourism, exploration, marketing, site surveying, and urban planning.

### BRIEF DESCRIPTION OF THE INVENTION

An aspect of the present disclosure provides a method for creating panoramic images for digitally exploring locations including the steps of creating flight plan instructions for an unmanned aerial vehicle over a target area, capturing, by the unmanned aerial vehicle, image data of the target area while executing the flight plan instructions and flying over the target area, creating a panoramic image of the target area from the captured image data, and storing the created panoramic image in a database of panoramic images. Each panoramic image corresponds to a different target area. Moreover, the method includes receiving, by an electronic device in communication with the database via a network, input for one of the different target areas to view the corresponding panoramic image. In response to determining a panoramic image is available for the one target area, the method displays the corresponding panoramic image.

In an embodiment of the present disclosure the flight plan instructions include location data of the target area, regions of interest within the target area, travel velocity between regions of interest, the time spent capturing image data of each different region of interest, and the elevation of the unmanned aerial vehicle while executing the flight plan instructions.

In another embodiment of the present disclosure in response to determining that a panoramic image is not available for the one target area, the method includes prompting an operator of the electronic device to update the database by creating a panoramic image for the one target area.

In yet another embodiment of the present disclosure the method includes creating a flight path for a different unmanned aerial vehicle when the operator decides to create a panoramic image of the one target area. The different unmanned aerial vehicle is associated with the operator. Moreover, the method includes capturing, by the different unmanned aerial vehicle, image data of the one target area, creating a panoramic image of the one target area, and storing the created panoramic image in the panoramic image database.

In yet another embodiment of the present disclosure the method includes creating a grid including nodes. The image data for each target area is captured within a five-hundred meter radius of a respective node.

In yet another embodiment of the present disclosure the method includes capturing the image data from less than four hundred feet above the target area.

In yet another embodiment of the present disclosure the method includes at least one of downloading the captured image data from a secure digital card in the unmanned aerial vehicle to the electronic device, and transmitting, over a network, the captured image data from the unmanned aerial vehicle to the electronic device.

Another aspect of the present disclosure provides a non-transitory computer-readable recording medium in an electronic device for creating panoramic images for digitally exploring locations. The non-transitory computer-readable recording medium stores one or more programs which when executed by a hardware processor performs the steps of the methods described above.

Another aspect of the present disclosure provides an electronic device for creating panoramic images for digitally exploring locations including a processor and a memory configured to store data. The electronic device is associated with a network and the memory is in communication with the processor and has instructions stored thereon which, when read and executed by the processor, cause the electronic device to create flight plan instructions for an unmanned aerial vehicle over a target area, receive image data of a target area, the image data being captured by an unmanned aerial vehicle while executing the flight plan instructions and flying over the target area. Moreover, the instructions when read and executed by the processor, cause the electronic device to create a panoramic image of the target area from the captured image data, and store the created panoramic image in a database of panoramic images. Each panoramic image corresponds to a different target area. Furthermore, the instructions when read and executed by the processor, cause the electronic device to receive input for one of the different target areas to view the corresponding panoramic image. In response to determining a panoramic image is available for the one target area, the instructions when read and executed by the processor, cause the electronic device to display the corresponding panoramic image.

In an embodiment of the present disclosure, the flight plan instructions include location data of the target area, regions of interest within the target area, travel velocity between regions of interest, the time spent capturing image data of each different region of interest, and the elevation of the unmanned aerial vehicle while executing the flight plan instructions.

In another embodiment of the present disclosure the instructions when read and executed by the electronic device, cause the electronic device to in response to determining that a panoramic image is not available for the one target area, prompt an operator of the electronic device to update the database by creating a panoramic image for the one target area.

In yet another embodiment of the present disclosure the instructions when read and executed by the electronic device, cause the electronic device to create flight plan instructions for a different unmanned aerial vehicle when the operator decides to create a panoramic image of the one target area. The different unmanned aerial vehicle is associated with the operator. Moreover, the instructions when read and executed by the electronic device, cause the electronic device to capture, by the different unmanned aerial vehicle, image data of the one target area, create a panoramic image of the one target area from image data of the one target area captured by the different unmanned aerial vehicle, and store the created panoramic image in the panoramic image database.

In yet another embodiment of the present disclosure the instructions when read and executed by the electronic device, cause the electronic device to create a grid including nodes, wherein the image data for each target area is captured within a five-hundred meter radius of a respective node.

In yet another embodiment of the present disclosure the image data is captured from less than four hundred feet above the target area.

In yet another embodiment of the present disclosure the instructions when read and executed by the electronic device, cause the electronic device to perform at least one of downloading the captured image data from a secure digital card in the unmanned aerial vehicle, and receiving via transmission over a network, the captured image data from the unmanned aerial vehicle.

### BRIEF DESCRIPTION OF THE DRAWINGS

FIG. 1 is a schematic diagram of an example computing system for creating panoramic images for digitally exploring locations according to an embodiment of the present disclosure;

FIG. 2 is a more detailed schematic diagram illustrating an unmanned aerial vehicle (UAV) in the system of FIG. 1;

FIG. 3 is a more detailed schematic diagram illustrating an electronic device in the system of FIG. 1;

FIG. 4 is a map of example topography in an urban area;

FIG. 5 is a diagram illustrating an example elevation view of the topography and a UAV relative to the topography; and

FIG. 6 is a flowchart illustrating an example method and algorithm for creating panoramic images for digitally exploring locations according to an embodiment of the present disclosure.

### DETAILED DESCRIPTION OF THE INVENTION

The following detailed description is made with reference to the accompanying drawings and is provided to assist in a comprehensive understanding of various example embodiments of the present disclosure. The following description includes various details to assist in that understanding, but these are to be regarded merely as examples and not for the purpose of limiting the present disclosure as defined by the appended claims and their equivalents. The words and phrases used in the following description are merely used to enable a clear and consistent understanding of the present disclosure. In addition, descriptions of well-known structures, functions, and configurations may have been omitted for clarity and conciseness. Those of ordinary skill in the art will recognize that various changes and modifications of the example embodiments described herein can be made without departing from the spirit and scope of the present disclosure.

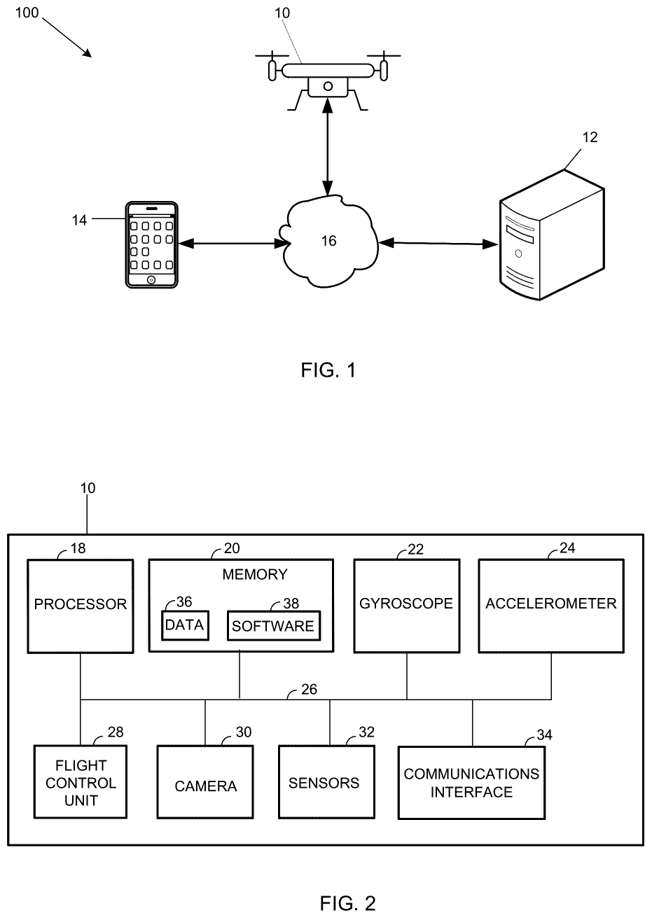

FIG. 1 is a schematic diagram of an example computing system 100 for creating panoramic images for digitally exploring locations according to an embodiment of the present disclosure. As shown in FIG. 1, the main elements of the system 100 include an unmanned aerial vehicle (UAV) 10, a server 12, and an electronic device 14 communicatively connected via a network 16.

The UAV 10 may be any type of UAV capable of performing the functions described herein.

The server 12 can be, for example, any type of server or computer implemented as a network server or network computer. The server 12 is an electronic device so may be alternatively referred to herein as an electronic device. Additionally, the server 12 and electronic device 14 may each alternatively be referred to as an information system.

The electronic device 14 can be any electronic device capable of at least communicating with the UAV 10 via the network 16, facilitating creation of flight plan instructions, transmitting flight plan instructions to the UAV 10, downloading applications over the Internet, running applications, capturing and storing data temporarily and/or permanently, and otherwise performing any and all functions described herein by any computer, computer system, server or electronic device included in the system 100. The electronic device 14 can be a hand-held portable device or a stationary electronic device. One example of the electronic device 14 is a smart phone. Other examples include, but are not limited to, a cellular phone, a tablet computer, a phablet computer, a laptop computer, a personal computer (PC), and any type of hand-held consumer electronic device having wired or wireless networking capabilities capable of performing the functions, methods, and/or algorithms described herein.

The electronic device 14 may be used to manage the UAV 10, for example, by communicating indirectly through the network 16 or directly to locate the UAV 10, identifying the UAV 10, ascertaining capabilities of the UAV 10, monitoring the operating status of the UAV 10, receiving sensor data generated by the UAV 10, and providing flight path instructions to the UAV 10.

The electronic device 14 is typically associated with a single person who operates the device. The person who is associated with and operates the electronic device 10 is referred to herein as a user or an operator.

The network 16 may be implemented as a 5G communications network. Alternatively, the network 20 may be implemented as any wireless network including, but not limited to, 4G, 3G, Wi-Fi, Global System for Mobile (GSM), Enhanced Data for GSM Evolution (EDGE), and any combination of a LAN, a wide area network (WAN) and the Internet. The network 16 may also be implemented as a radio access network (RAN) that includes a core network and one or more base stations (not shown). As such, the RAN may include a long-term evolution (LTE) network or other third generation (3G), fourth generation (4G) wireless network, or fifth-generation (5G) wireless network. Additionally, or alternatively, the network 16 may be implemented by one or more other communication networks, such as, but not limited to, a satellite communication network, or a microwave radio network.

It is contemplated by the present disclosure that the number of UAVs 10, servers 12, and electronic devices 14 is not limited to the number shown in the system 100. Rather, any number of UAVs 10, servers 12, and electronic devices 14 may be included in the system 100.

FIG. 2 is a more detailed schematic diagram illustrating the UAV 10. The UAV 10 includes components such as, but not limited to, one or more processors 18, a memory 20, a gyroscope 22, an accelerometer 24, a bus 26, a flight control unit 28, a camera 30, sensors 32 and a communications interface 34. General communication between the components in the UAV 10 is provided via the bus 26.

The processor 18 executes software instructions, or computer programs, stored in the memory 20. As used herein, the term processor is not limited to just those integrated circuits referred to in the art as a processor, but broadly refers to a computer, a microcontroller, a microcomputer, a programmable logic controller, an application specific integrated circuit, and any other programmable circuit capable of executing at least a portion of the functions and/or methods described herein. The above examples are not intended to limit in any way the definition and/or meaning of the term “processor.”

The memory 20 may be any non-transitory computer-readable recording medium. Non-transitory computer-readable recording media may be any tangible computer-based device implemented in any method or technology for short-term and long-term storage of information or data. Moreover, the non-transitory computer-readable recording media may be implemented using any appropriate combination of alterable, volatile or non-volatile memory or non-alterable, or fixed, memory. The alterable memory, whether volatile or non-volatile, can be implemented using any one or more of static or dynamic RAM (Random Access Memory), flash memory or the like. Similarly, the non-alterable or fixed memory can be implemented using any one or more of ROM (Read-Only Memory), PROM (Programmable Read-Only Memory), EPROM (Erasable Programmable Read-Only Memory), EEPROM (Electrically Erasable Programmable Read-Only Memory) or the like.

The memory 20 may be used to store any type of data 36 including, but not limited to, image data, panoramic images, and flight plan instructions.

Additionally, the memory 20 can be used to store software 38. As used herein, the term “software” is intended to encompass an executable computer program that exists permanently or temporarily on any non-transitory computer-readable recordable medium that causes the UAV 10 to perform at least a portion of the functions, methods, and/or algorithms described herein.

The gyroscope 22 and the one or more accelerometers 24 generate data regarding rotation and translation of the UAV 10 that may be communicated to the processor 18 and the memory 20 via the bus 26. The gyroscope measures and maintains orientation and angular velocity and thus facilitates accurately and reliably navigating and controlling movement of the UAV 10. The accelerometer can be used to facilitate stabilizing the UAV 10 by measuring the orientation of the UAV 10 as well as the effects of sudden acceleration due to wind or sharp turns.

The flight control unit 28 may include any appropriate avionics, control actuators, or other equipment required to fly the UAV 10.

The camera 30 captures image data. Image data can be a digital image or a sequence of digital images. As used herein, capture means to record data temporarily or permanently, for example, image data of the topography in a target area. The camera 30 can be one or more imaging devices configured to record image data of the topography in a target area. The camera 30 is integrated into the UAV 10 and incorporates a sensor, for example and without limitation, a CCD or CMOS sensor.

Sensors 32 include, but are not limited to, at least one temperature sensor, at least one pressure sensor, at least one humidity sensor, at least one gas sensor, at least one altitude sensor, at least one velocity sensor, and at least one location sensor.

The communications interface 34 may include one or more transceivers to enable the UAV 10 to communicate with, for example, the server 12, the electronic device 14, and a service platform (not shown) via the network 16, or any other computing devices (not shown). The electronic device 14 may be in communication with the UAV 10 directly or indirectly. The communications interface 34 may alternatively, or additionally, include a (e.g., long-range) transceiver(s) to permit the UAV 10 to communicate with the network 16.

The communications interface 34 may additionally, or alternatively, include second (e.g., short-range) transceiver(s) to permit communications with sensors, docking stations, other UAVs or other computing devices (not shown). Such second transceivers can be implemented by a type of transceiver supporting short-range wireless networking such as, but not limited to, Wi-Fi transceivers, Bluetooth® transceivers, infrared (IR) transceivers, and other transceivers that are configured to allow the UAV 10 to intercommunicate via an ad-hoc or other wireless network.

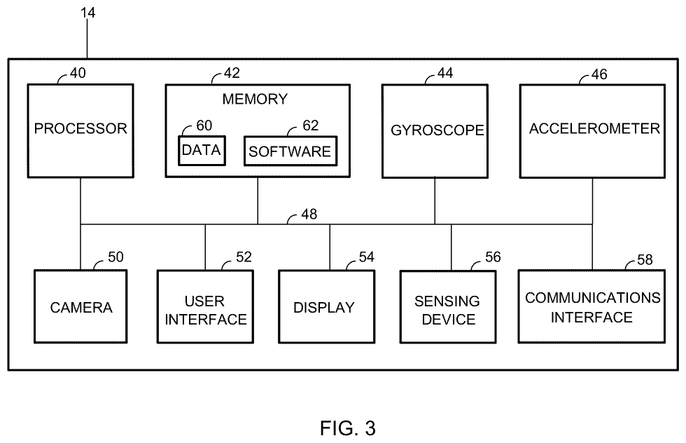

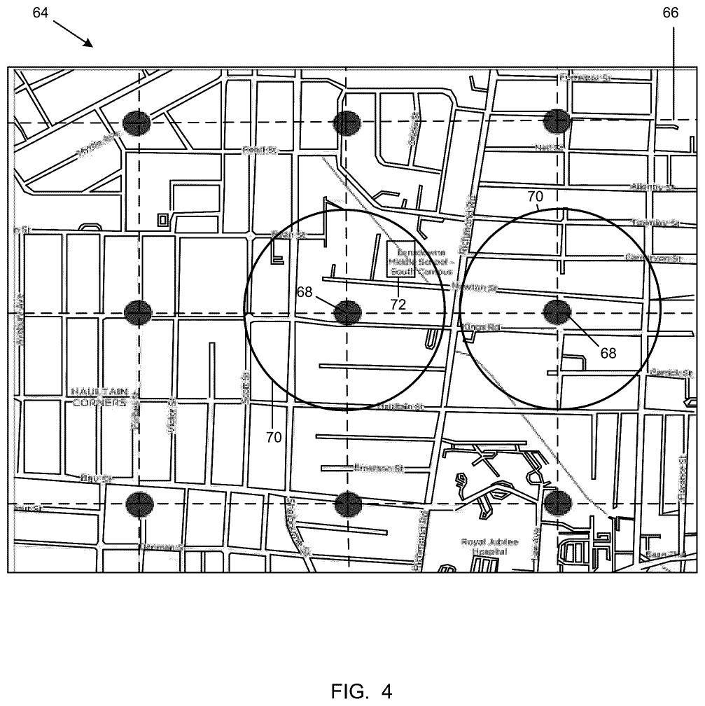

FIG. 3 is a more detailed schematic diagram illustrating the electronic device 14. The electronic device 14 includes components such as, but not limited to, one or more processors 40, a memory 42, a gyroscope 44, an accelerometer 46, a bus 48, a camera 50, a user interface 52, a display 54, a sensing device 56, and a communications interface 58. General communication between the components in the electronic device 14 is provided via the bus 48.

The processor 40 executes instructions, or computer programs, stored in the memory 42. As used herein, the term processor is not limited to just those integrated circuits referred to in the art as a processor, but broadly refers to a computer, a microcontroller, a microcomputer, a programmable logic controller, an application specific integrated circuit, and any other programmable circuit capable of executing at least a portion of the functions and/or methods described herein. The above examples are not intended to limit in any way the definition and/or meaning of the term “processor.”

As used herein, the term “computer program” is intended to encompass an executable program that exists permanently or temporarily on any non-transitory computer-readable recordable medium that causes the processor to perform at least a portion of the functions and/or methods described herein. Application programs 62, also known as applications, are computer programs stored in the memory 42. Application programs 62 include, but are not limited to, an operating system, an Internet browser application, authentication applications and any special computer program that manages the relationship between application software and any suitable variety of hardware that helps to make-up a computer system or computing environment.

The memory 60 may be any non-transitory computer-readable recording medium used to store data such as, but not limited to, computer programs, flight plan instructions, image data, panoramic image data, and maps.

Non-transitory computer-readable recording media may be any tangible computer-based device implemented in any method or technology for short-term and long-term storage of information or data. Moreover, the non-transitory computer-readable recording media may be implemented using any appropriate combination of alterable, volatile or non-volatile memory or non-alterable, or fixed, memory. The alterable memory, whether volatile or non-volatile, can be implemented using any one or more of static or dynamic RAM (Random Access Memory), a floppy disc and disc drive, a writeable or re-writeable optical disc and disc drive, a hard drive, flash memory or the like. Similarly, the non-alterable or fixed memory can be implemented using any one or more of ROM (Read-Only Memory), PROM (Programmable Read-Only Memory), EPROM (Erasable Programmable Read-Only Memory), EEPROM (Electrically Erasable Programmable Read-Only Memory), an optical ROM disc, such as a CD-ROM or DVD-ROM disc, and disc drive or the like. Furthermore, the non-transitory computer-readable recording media may be implemented as smart cards, SIMs, any type of physical and/or virtual storage, or any other digital source such as a network or the Internet from which a central user data server can read computer programs, applications or executable instructions.

The gyroscope 44 and the one or more accelerometers 46 generate data regarding rotation and translation of the electronic device 14 that may be communicated to the processor 40 and the memory 42 via the bus 48. Stationary electronic devices 14 may not include the gyroscope 44 or the accelerometer 46 or may not include either.

The camera 50 captures image data. The camera 50 is capable of recording image data under any lighting conditions including infrared light. The camera 50 may be integrated into the electronic device 14 as one or more front-facing cameras and/or one or more rear facing cameras that each incorporates a sensor, for example and without limitation, a CCD or CMOS sensor.

The user interface 52 and the display 54 allow interaction between a user and the electronic device 14. The display 54 may include a visual display or monitor that displays information. For example, the display 54 may be a Liquid Crystal Display (LCD), an active matrix display, plasma display, or cathode ray tube (CRT). The user interface 52 may include a keypad, a camera, a keyboard, a mouse, an illuminator, a signal emitter, a microphone, and/or speakers.

Moreover, the user interface 52 and the display 54 may be integrated into a touch screen display. Accordingly, the display may also be used to show a graphical user interface, which can display various data and provide “forms” that include fields that allow for the entry of information by the user. Touching the screen at locations corresponding to the display of a graphical user interface allows the person to interact with the electronic device 14 to enter data, change settings, control functions, etc. Consequently, when the touch screen is touched, the user interface 52 communicates this change to the processor 40, and settings can be changed or user entered information can be captured and stored in the memory 42.

The sensing device 56 may include Radio Frequency Identification (RFID) components or systems for receiving information from other devices in the system 100 and for transmitting information to other devices in the system 100. The sensing device 56 may alternatively, or additionally, include components with Bluetooth, Near Field Communication (NFC), infrared, or other similar capabilities.

The communications interface 58 provides the electronic device 14 with two-way data communications. Moreover, the communications interface 58 may enable the electronic device 14 to conduct wireless communications such as cellular telephone calls or to wirelessly access the Internet over the network 16. By way of example, the communications interface 58 may be a digital subscriber line (DSL) card or modem, an integrated services digital network (ISDN) card, a cable modem, or a telephone modem to provide a data communication connection to a corresponding type of telephone line. As another example, the communications interface 58 may be a local area network (LAN) card (e.g., for Ethernet™ or an Asynchronous Transfer Model (ATM) network) to provide a data communication connection to a compatible LAN. As yet another example, the communications interface 58 may be a wire or a cable connecting the electronic device 14 with a LAN, or with accessories such as, but not limited to, keyboards or biometric capture devices used to support login by system administrators. Further, the communications interface 58 may include peripheral interface devices, such as a Universal Serial Bus (USB) interface, a PCMCIA (Personal Computer Memory Card International Association) interface, and the like. Thus, it should be understood the communications interface 58 may enable the electronic device 14 to conduct any type of wireless or wired communications such as, but not limited to, accessing the Internet.

The communications interface 58 also allows the exchange of information across the network 16. The exchange of information may involve the transmission of radio frequency (RF) signals through an antenna (not shown). Moreover, the exchange of information may be between the electronic device 14 and any other electronic device capable of communicating over the network 16 including the UAV 10.

The server 12 may include the same or similar components as described herein with regard to the electronic device 14. The server 12 need not include all the same components described herein with regard to the electronic device 14. For example, the server 12 may not include the gyroscope 44, accelerometer 46, and/or the camera 50.

Known Geographic Information Systems rely on visualization tools that provide up-to-date and accurate location imagery which can be interacted with digitally for purposes of spatial analysis, urban planning and development, geographical education, and research, tourism and navigation, and marketing. It is known to use geo-visualization tools such as satellite imagery, maps, and Lidar to produce visual outputs of location information. However, a disadvantage of geo-visualization tools like satellite imagery is that the images do not have a high enough resolution of small, localized areas such as parks, businesses, and homes. As a result, satellite imagery and other known geo-visualization tools cannot provide images having resolution that provides the level of detail required to withstand scrutiny in tourism, exploration, marketing, site surveying, and urban planning applications.

To address these problems, the electronic device 14 can create flight plan instructions for the unmanned aerial vehicle (UAV) 10 over a target area. The UAV 10 can capture image data of the target area while executing the flight plan instructions and flying over the target area. A panoramic image of the target area can be created from the captured image data. The created panoramic image can be stored in a database of panoramic images. Each panoramic image corresponds to a different target area. An electronic device in communication with the database via a network, can receive input for one of the different target areas to view the corresponding panoramic image. In response to determining a panoramic image is available for the one target area, the corresponding panoramic image can be displayed by the electronic device.

FIG. 4 is a map 64 of example topography in an urban area. Alternatively, the topography may be rural or suburban. A grid 66 is electronically superimposed on the map 64. Nodes 68 identify intersections within the grid 66. Any mathematical process may be used to superimpose the grid 66 on the map 64. The nodes 68 may be five hundred meters apart. However, the nodes 68 may alternatively be separated by any distance that enables quickly creating high resolution panoramic images that can be quickly and easily integrated into the map 64.

The map 64 may be stored in the server 12 or the electronic device 14. Panoramic images for target areas within the map 66 may be integrated into the map 64 in any manner. Two example circular target areas 70 are integrated into the map 64. The target areas have a radius of five hundred meters. Alternatively, the target areas 70 may have any radius that does not exceed the operating range of the UAV 10 and that facilitates capturing high resolution image data that can be used for creating high resolution panoramic images. The target areas 70 may alternatively be any shape that facilitates capturing image data proximate a particular node 68 that does not exceed the operating range of the UAV 10.

It is contemplated by the present disclosure that each node 68 constitutes a control point that enables locating a corresponding target area 70 within the map 64.

A target area 70 includes a region of interest 72 that may be of particular interest to users. The region of interest 72 includes a middle school that parents may want to view before deciding whether or not their children should attend the school. Different target areas 70 may include different regions of interest 72. For example, for a target area 70 in Rome, Italy, a region of interest 72 may be the coliseum. It is contemplated by the present disclosure that any number of regions of interest 72 may be included in a target area 70.

The operator of the UAV 10 may create flight plan instructions for the UAV 10 to capture image data within a target area 70. The instructions may be created using the electronic device 14 associated with the operator or any other device in the systems 100. The instructions may include the global positioning system (GPS) coordinates of a node 68, the shape and size of the target area 70, GPS coordinates for any region of interest 72, flight speed, whether or not the UAV 10 should stop when capturing image data, for example, of a region of interest 72. The flight plan instructions for the UAV 10 are typically different each time image data is captured for a same or different target area 70.

Although the operator of the UAV 10 creates the flight plan instructions using the electronic device 14, it is contemplated by the present disclosure that the electronic device 14 may automatically create the flight plan instructions.

The flight plan instructions may be saved to the memory 42 of the electronic device 14 or the server 12. When the UAV 10 and operator are ready to begin capturing image data in a desired target area 70, the operator may touch, press, or otherwise activate a button or icon displayed by the electronic device 14 to initiate execution of the flight plan instructions. In response, the electronic device 14 transmits the flight plan instructions to the UAV 10. In response to receiving the instructions, the UAV 10 executes the instructions while capturing image data with the camera 30 and flying over the desired target area 70. The captured image data may be stored in the memory 20 of the UAV 10. Alternatively, or additionally, the captured image data may be transmitted to the electronic device 14, the server 12, or both, for storage therein.

Although the operator manually touches, presses, or otherwise activates a button or icon displayed by the electronic device 14 to initiate execution of the flight plan instructions as described herein, alternatively, the electronic device 14 may automatically initiate execution of the flight plan instructions. For example, the electronic device 14 may automatically transmit the flight plan instructions to the UAV 10. If the UAV 10 is not ready to receive the instructions, the electronic device 14 may retransmit the instructions until the UAV 10 is ready to receive the instructions.

The UAV 10 may also generate a three hundred sixty-degree panoramic image from the captured image data and may store the panoramic image in the memory 20. The UAV 10 may transmit the panoramic image to the electronic device 14 and/or the server 12 with the captured image data or separate from the image data. Alternatively, the UAV 10 may not generate the panoramic image. Instead, the electronic device 14 or the server 12 can generate the panoramic image from the captured image data received from the UAV 10.

The generated panoramic image can be integrated into the map 64 and associated with a corresponding node 68 and target area 70. It is contemplated by the present disclosure that a three hundred sixty-degree panoramic image is not generated for each target area in the map 64. The map 64 may be displayed by the electronic device for the user to see. The user can interact with the map 64 to view panoramic images associated with corresponding target areas 70. More specifically, the user may click or otherwise activate the node 68 corresponding to a desired target area 70 to view the panoramic image associated with the desired target area and thus digitally explore a location. As a result, users are enabled to view the topography of a target area 70 before deciding whether or not to visit the target area 70.

Using three hundred sixty-degree panoramic images provides a more immersive experience which allows people to digitally explore a location in a virtual reality-like environment. The immersive nature enables a better understanding and visualization of spatial relationships which can aid, for example, travelers when deciding whether or not to visit and explore a location.

Any member of the public may create a panoramic image for a desired target area 70 for which a panoramic image has not been created. More specifically, any member of the public may create flight plan instructions using his or her electronic device 14, which can be transmitted to his or her UAV 10. Alternatively, the electronic device 14 may automatically create the flight plan instructions. The UAV 10 executes the flight plan instructions while capturing image data with the camera 30 and flying over the desired target area 70. A three hundred sixty-degree panoramic image may be created by the UAV 10 or the electronic device 14 of the user and transmitted to the server 12. Alternatively, the captured image data may be transmitted to the server 12, for the creation of a panoramic image for the desired target area 70. Thus, it can be seen that any member of the public can create panoramic images that can be added to the map 64.

The panoramic image for a target area 70 may be updated for any reason. Typically, the panoramic image for a target area 70 is updated when the topography changes. For example, an old dilapidated building may be demolished and replaced with a beautiful museum and gardens. Any member of the public may create an updated panoramic image for the target area 70. The panoramic image, or the captured image data, may be transmitted to the server 12 or the electronic device 14 from the UAV 10. The electronic device 14 may transmit the panoramic image or the captured image data to the server 12. The server 12 can replace the current panoramic image with the updated panoramic image for the target area 70. Thus, it can be seen that the panoramic image for a target area can be updated quickly at little cost by any member of the public. In view of the above, it can be seen that UAVs 10 can effectively be deployed quickly on demand, allowing for the collection of up-to-date imager data. Known methods, for example, satellite imagery is captured infrequently so may not reflect changes in the topography.

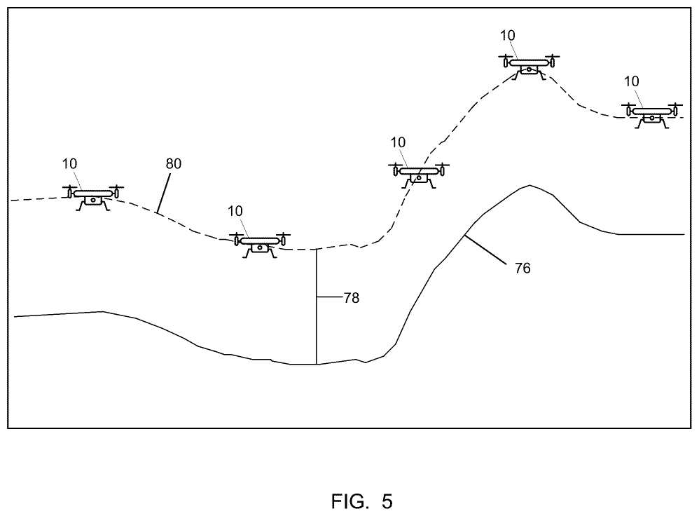

FIG. 5 is a diagram illustrating an elevation view of the topography 76 in an example target area 70 with the UAV 10 flying over the topography 76. Generally, the UAV 10 flies at a constant altitude of less than four hundred feet above the ground. As a result, the vertical profile 80 travelled by the UAV 10 follows or mimics the vertical profile of the ground. It should be understood that as a result of capturing image data at an altitude of less than four hundred feet, haze, cloud cover and other weather phenomena have less effect on the quality of the captured image data. As a result of at least the lower elevation and reduced weather impact, image data captured at less than four hundred feet above the ground has a much better resolution than images captured using other known methods. As a result, three-hundred sixty-degree panoramic images created from the captured image data also have better resolution. The resolution is better than panoramic images created from images captured using other know methods, for example, satellite imagery.

Although the UAV 10 is typically flown at an altitude of just less than four hundred feet, it is contemplated by the present disclosure that the UAV 10 may be flown at various altitudes less than four hundred feet and at various angles to enable capturing image data from different perspectives which facilitates obtaining more comprehensive image data for regions of interest. Such regions of interest can include narrow or obstructed spaces, dense forests, or urban canyons. Known methods, for example, satellite imagery are not as flexible so cannot provide such comprehensive image data.

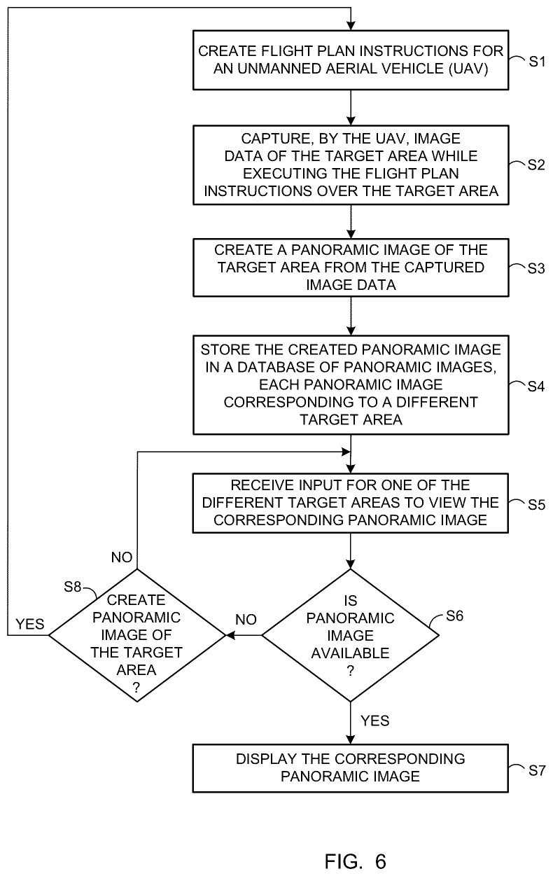

FIG. 6 is a flowchart illustrating an example method and algorithm for creating panoramic images for digitally exploring locations according to an embodiment of the present disclosure. FIG. 6 illustrates example operations performed by the UAV 10, the electronic device 14, and the server 12 while creating panoramic images for digitally exploring locations.

In step S1, the software 66 executed by the processor 44 causes the electronic device 14 to facilitate creating flight plan instructions for the UAV 10 to be executed while flying over a desired target area 70. Alternatively, the electronic device 14 may automatically create the flight plan instructions. When the UAV 10 and operator are ready to begin capturing image data in a desired target area 70, the operator may touch, press, or otherwise activate a button or icon displayed by the electronic device 14 to initiate execution of the flight plan instructions. In response, the electronic device 14 transmits the flight plan instructions to the UAV 10.

Although the operator manually touches, presses, or otherwise activates a button or icon displayed by the electronic device 14 to initiate execution of the flight plan instructions as described herein, alternatively, the electronic device 14 may automatically initiate execution of the flight plan instructions. For example, the electronic device 14 may automatically transmit the flight plan instructions to the UAV 10. If the UAV 10 is not ready to receive the instructions, the electronic device 14 may retransmit the instructions until the UAV 10 is ready to receive the instructions.

Next, in step S2, in response to receiving the flight plan instructions from the electronic device 14 the software 38 executed by the processor 18 causes the UAV 10 to capture image data of the desired target area while executing the flight plan instructions and flying over the desired target area 70. The captured image data can be transmitted to the server 12. In step S3, the software executed by the processor in the server 12 causes the server 12 to create a three hundred sixty-degree panoramic image of the desired target area from the captured image data. Alternatively, the captured image data can be transmitted to the electronic device 14 which may create the panoramic image.

Next, in step S4, the software executed by the processor in the server 12 causes the server 12 to store the panoramic images in a database of panoramic images. Each panoramic image corresponds to a different target area. In step S5, the software executed by the processor in the server 12 causes the server 12 to receive input for one of the different target areas to view the corresponding panoramic image. The input can be received from the electronic device 14 of a user who clicked or otherwise activated the node 66 associated with the desired target area 70. Next, in step S6, the software executed by the processor in the server 12 causes the server 12 to determine whether the panoramic image is available. If so, in step S7, the software 62 executed by the processor 40 causes the electronic device 14 the user to display the corresponding panoramic image.

However, in step S6, when the panoramic image is not available, in step S8, the software 62 executed by the processor 40 causes the electronic device 14 to determine whether a panoramic image for the target area 70 will be created. More specifically, the electronic device 14 of the user displays a message prompting the user to create a panoramic image for the target area. If the user agrees to create a panoramic image, in step S1, the software 62 executed by the processor 40 causes the electronic device 14 to facilitate creating flight plan instructions for the UAV 10 to be executed while flying over the target area 70. Otherwise, when the user refuses to create a panoramic image, in step S5, the software executed by the processor in the server 12 causes the server 12 to receive input for one of the different target areas to view the corresponding panoramic image.

Using the method and algorithm for creating panoramic images for digitally exploring locations facilitates generating higher resolution panoramic images that include the level of detail required to survive the scrutiny encountered in tourism, exploration, marketing, site surveying, and urban planning. Additionally, the methods and algorithms described herein facilitate quickly and inexpensively updating a database of panoramic images. Moreover, the methods and algorithms described herein facilitate enhancing the efficiency of image data capture which facilitates reducing image acquisition and post capture processing as well as related costs.

The example methods and algorithms described herein may be conducted partly by the UAV 10, partly by the electronic device 14 and partly by the server 12 via the network 16. Alternatively, the example methods and algorithms described herein may be conducted partly by the UAV 10 and partly by the electronic device 14 via the network 16, or party by the UAV 10 and partly by the server 12 via the network 16. Moreover, the example methods described herein may be conducted on other computer systems (not shown) other electronic devices (not shown). Thus, it should be understood that it is contemplated by the present disclosure that the example methods and algorithms described herein may be conducted using any combination of computers, computer systems, and electronic devices (not shown). Furthermore, data described herein as being stored in the electronic device 14 may alternatively, or additionally, be stored in the server 12, or in any computer system (not shown) or electronic device (not shown) operable to communicate with the electronic device 14 over the network 16.

Additionally, the example methods and algorithms described herein may be implemented with any number and organization of computer program components. Thus, the methods and algorithms described herein are not limited to specific computer-executable instructions. Alternative example methods and algorithms may include different computer-executable instructions or components having more or less functionality than described herein.

The example methods and/or algorithms described above should not be considered to imply a fixed order for performing the method and/or algorithm steps. Rather, the method and/or algorithm steps may be performed in any order that is practicable, including simultaneous performance of at least some steps. Moreover, the method and/or algorithm steps may be performed in real time or in near real time. It should be understood that, for any method and/or algorithm described herein, there can be additional, fewer, or alternative steps performed in similar or alternative orders, or in parallel, within the scope of the various embodiments, unless otherwise stated. Furthermore, the invention is not limited to the embodiments of the methods and/or algorithms described above in detail.

What is claimed is:

1. A method of creating panoramic images for digitally exploring locations comprising the steps of:
creating flight plan instructions for an unmanned aerial vehicle over a target area;
capturing, by the unmanned aerial vehicle, image data of the target area while executing the flight plan instructions and flying over the target area;
creating a panoramic image of the target area from the captured image data;
storing the created panoramic image in a database of panoramic images, each panoramic image corresponding to a different target area;
receiving, by an electronic device in communication with the database via a network, input for one of the different target areas to view the corresponding panoramic image; and
in response to determining a panoramic image is available for the one target area, displaying the corresponding panoramic image.

2. The method according to claim 1, wherein the flight plan instructions comprise:
location data of the target area;
regions of interest within the target area;
travel velocity between regions of interest;
the time spent capturing image data of each different region of interest; and
elevation of the unmanned aerial vehicle while executing the flight plan instructions.

3. The method according to claim 1, further comprising in response to determining that a panoramic image is not available for the one target area, prompting an operator of the electronic device to update the database by creating a panoramic image for the one target area.

4. The method according to claim 3, further comprising:
creating flight plan instructions for a different unmanned aerial vehicle when the operator decides to create a panoramic image of the one target area, wherein the different unmanned aerial vehicle is associated with the operator;
capturing, by the different unmanned aerial vehicle, image data of the one target area;
creating a panoramic image of the one target area; and
storing the created panoramic image in the panoramic image database.

5. The method according to claim 1, further comprising creating a grid including nodes, wherein the image data for each target area is captured within a five-hundred meter radius of a respective node.

6. The method according to claim 1, said capturing step comprising capturing the image data from less than four hundred feet above the target area.

7. The method according to claim 1, further comprising at least one of:
downloading the captured image data from a secure digital card in the unmanned aerial vehicle to the electronic device; and
transmitting, over a network, the captured image data from the unmanned aerial vehicle to the electronic device.

8. An electronic device for creating panoramic images for digitally exploring locations comprising:
a processor; and
a memory configured to store data, said controller being associated with a network and said memory being in communication with said processor and having instructions stored thereon which, when read and executed by said processor, cause said electronic device to:
create flight plan instructions for an unmanned aerial vehicle over a target area;
receive image data of the target area, the image data being captured by the unmanned aerial vehicle while executing the flight plan instructions and flying over the target area;
create a panoramic image of the target area from the captured image data;
store the created panoramic image in a database of panoramic images, each panoramic image corresponding to a different target area;
receive input for one of the different target areas to view the corresponding panoramic image; and
in response to determining a panoramic image is available for the one target area, display the corresponding panoramic image.

9. The electronic device according to claim 8, wherein the flight plan instructions comprise:
location data of the target area;
regions of interest within the target area;
travel velocity between regions of interest;
the time spent capturing image data of each different region of interest; and
elevation of the unmanned aerial vehicle while executing the flight plan instructions.

10. The electronic device according to claim 8, wherein the instructions when read and executed by said electronic device, cause said electronic device to in response to determining that a panoramic image is not available for the one target area, prompt an operator of said electronic device to update the database by creating a panoramic image for the one target area.

11. The electronic device according to claim 10, wherein the instructions when read and executed by said electronic device, cause said electronic device to:
create a flight plan instructions for a different unmanned aerial vehicle when the operator decides to create a panoramic image of the one target area, wherein the different unmanned aerial vehicle is associated with the operator;
capture, by the different unmanned aerial vehicle, image data of the one target area;
create a panoramic image of the one target area from image data of the one target area captured by the different unmanned aerial vehicle; and
store the created panoramic image in the panoramic image database.

12. The electronic device according to claim 8, wherein the instructions when read and executed by said electronic device, cause said electronic device to create a grid including nodes, wherein the image data for each target area is captured within a five-hundred meter radius of a respective node.

13. The electronic device according to claim 8, wherein the image data is captured from less than four hundred feet above the target area.

14. The electronic device according to claim 8, wherein the instructions when read and executed by said electronic device, cause said electronic device to perform at least one of:
download the captured image data from a secure digital card in the unmanned aerial vehicle; and
receive via transmission over a network, the captured image data from the unmanned aerial vehicle.

15. A non-transitory computer-readable recording medium in an electronic device for creating panoramic images for digitally exploring locations, the non-transitory computer-readable recording medium storing one or more programs which when executed by a hardware processor cause the non-transitory recording medium to perform steps comprising:
creating flight plan instructions for an unmanned aerial vehicle over a target area;
receiving image data of the target area, the image data being captured by the unmanned aerial vehicle while executing the flight plan instructions and flying over the target area;
creating a panoramic image of the target area from the captured image data;
storing the created panoramic image in a database of panoramic images, each panoramic image corresponding to a different target area;
receiving input for one of the different target areas to view the corresponding panoramic image; and
in response to determining a panoramic image is available for the one target area, displaying the corresponding panoramic image.

16. The non-transitory computer-readable recording medium according to claim 15, wherein the flight plan instructions comprise:
location data of the target area;
regions of interest within the target area;
travel velocity between regions of interest;
the time spent capturing image data of each different region of interest; and
elevation of the unmanned aerial vehicle while executing the flight plan instructions.

17. The non-transitory computer-readable recording medium according to claim 15, further comprising in response to determining that a panoramic image is not available for the one target area, prompting an operator of the electronic device to update the database by creating a panoramic image for the one target area.

18. The non-transitory computer-readable recording medium according to claim 17, further comprising:
creating flight plan instructions for a different unmanned aerial vehicle when the operator decides to create a panoramic image of the one target area, wherein the different unmanned aerial vehicle is associated with the operator;
capturing, by the different unmanned aerial vehicle, image data of the one target area;
creating a panoramic image of the one target area; and
storing the created panoramic image in the panoramic image database.

19. The non-transitory computer-readable recording medium according to claim 15, further comprising creating a grid including nodes, wherein the image data for each target area is captured within a five-hundred meter radius of a respective node.

20. The non-transitory computer-readable recording medium according to claim 15, wherein the image data is captured from less than four hundred feet above the target area.
